(19) United States
(12) Patent Application Publication
(10) Pub. No.: US 2011/0215791 A1
(43) Pub. Date: Sep. 8, 2011

(54) Compensation schemes for the voltage droop of solid-state Marx modulators

(75) Inventors: Ping Chen, Rancho Palos Verdes, CA (US); Martin L. Lundquist, Rancho Palos Verdes, CA (US); David U.L. Yu, Rancho Palos Verdes, CA (US)

(73) Assignee: DULY Research Inc.

(21) Appl. No.: 12/660,731

(22) Filed: Mar. 2, 2010

(51) Int. Cl. H02M 3/156

(52) U.S. Cl. 323/351

(57) ABSTRACT

A novel design scheme for the compensation circuitry of solid-state Marx modulators has been described for enhancing the compensation ability of the compensation cells of the Marx modulators and simplifying the entire circuitry. High-speed solid-state switches are adopted in the compensation circuitry for the control of the compensation actions. Inductive components and diodes are used in the design scheme to smooth voltage curve.

### GOVERNMENT RIGHTS

This invention was made with government support under Grant No. DE-FG02-08ER85052 awarded by the U.S. Energy Department. The government may have certain rights in the invention.

### BACKGROUND OF THE INVENTION

1. Field of the Invention

The invention illustrates a design scheme for a pulse compensation circuitry for Marx modulators, specifically, high-voltage solid-state Marx modulators. Inductive components regulated by solid-state switches are used to reliably compensate the voltage droop of the long pulse output of a Marx modulator. The invention also applies to solid-state Marx pulsers that have a large voltage droop in output voltage pulses.

2. Description of Prior Art

A Marx generator is a device to transform a low charge voltage to a high output voltage pulse. It is a robust, low-impedance source of electrical energy that has been utilized in a variety of high-peak-power applications for the past several decades. In recent year, Marx generators using new solid-state switches, e.g. Metal Oxide Semiconductor Field Effect Transistors (MOSFET) and Insulated Gate Bipolar Transistor (IGBT), have been studied for the application of high voltage modulators. Marx modulators offer an alternative to traditional high voltage (HV) modulators for rf power sources. The merits are compact size, high-energy efficiency, high reliability, pulse width control and cost reduction. The use of solid-state switches with electrical current interruption capability, in place of spark gap switches or Silicon-Controlled Rectifier (SCR) switches, gives Marx generators the ability to produce square-shaped output pulses at very high rep rates, and also allows the output pulse to change width from one pulse to the next, a capability that gives the generator the ability to adapt rapidly to changing load requirements.

Ideally, the high voltage pulse output by the Marx modulator should have a flat top pulse in rf applications. There is no intrinsic limitation for the Marx modulator to generate a flat top pulse if its output voltage pulse is short or if the resistance of the Marx modulator's load is high so that their circuit's time constant is much longer than the pulse length used. However, a great challenge appears if the Marx modulator has a long output pulse or a very small load. The output voltage droops significantly in the latter case because, when discharging, a Marx generator can be approximated to be a simple capacitor having the capacitance of approximately Cₘ, if parasitic inductance is small, with the load represented by a resistance R_{L}. The entire modulator circuit together with its load, e.g. a klystron or a magnetron, is a simple discharging RC circuit with a time-constant t=Cₘ·R_{L}, which determines the severity of the voltage droop at the end of a voltage pulse. A reduction in the time constant or an increase of the voltage pulse duration would lead to a larger voltage reduction at the end of a voltage pulse, which is generally not acceptable for an rf load. To limit the voltage droop in a narrow range that is required by the load, designers of the Marx modulator need to increase the time-constant t. Since the load is normally not changeable, the total capacitance, Cₘ, of the Marx modulator need to be increased dramatically, which is equivalent to increasing total stored electrical energy of the Marx modulator and will incur a great amount of expense.

To circumvent this problem, researchers tried to exploit compensation circuitry to reduce the voltage droop of the Marx modulators in recent years. The compensation circuitry consists of tens of vernier cells (see papers of G. Leyh, 2005 Pulsed Power Conference & Particle Accelerator Conference 2007) that have a similar structure to that of the main cells of the Marx generator, but have much lower charge voltage. In operation, the vernier cells are turned on one by one within the flat-top pulse. Their output voltages are superposed on the output voltage of the Marx main cell (MMC) bank so that the voltage droop of the MMC bank is compensated. The advantage of using a compensation circuitry in a high voltage modulator is that the circuitry can greatly reduce the stored electric energy in its capacitor bank while still limiting its pulsed voltage droop to the specified range required by the rf load. Several compensation circuitries were designed with the same topology as the main cells of the Marx modulators but lower charge voltage and utilized in the Marx modulators. However, some problems still exist in these designs. First, the voltage of the compensation cells in series of the MMC bank of the Marx modulators superposes on the voltage output of the bank, and forms sawtooth shapes on the output voltage pulse. The charge voltage of the compensation cells would need to be lowered in order to control the sawtooth height, leading to a difference between the charge voltage of a MMC and that of the compensation cell. Two different charge sources would need to be employed in the same Marx generator. Second, the compensation cells cannot provide real-time compensation. Only at a pre-set time interval when a compensation cell is switched on. Third, many compensation cells are needed for a long output pulse because the compensation cell storage energy is low and their compensation ability is limited when they are charged with a low voltage. Fourth, low charge voltage will result in relatively larger ohmic loss due to higher charge current, and will thus diminish the energy utilization ratio. All of these problems not only complicate the circuit design, but also greatly increase the cost of the circuitry with uncertain compensation results because, if there are too many cells in the compensation circuitry, it will increase the parasitic inductance and may cause uncontrollable fluctuations during the flattop of the pulsed voltage output.

This invention provides an effective way to compensate the voltage droop of the MMC banks of the Marx modulators, to simplify the overall circuitry of the Marx modulators, and to lower their fabrication cost. Further objectives and advantages of the invention will become apparent from a consideration of the drawings and ensuing description.

### SUMMARY OF THE INVENTION

Solid-state switches can turn on/off thousands of times per second and their on/off time is on the order of microsecond or shorter. The existing compensation circuitry for Marx modulators, which has low level of stored electrical energy, can only make use of one time switching action of the solid-state switches because of the voltage superposition, and thus has insufficient compensation capability. This invention provides a new scheme to design a compensation circuitry for the MMC banks of the Marx modulators. It incorporates the advantages of the fast speed of the electrically triggered solid-state switches, which are relatively easy to operate and have the ability of electrical current interruption, and with additional inductive components to resist any abrupt change of current in the circuitries. The compensation circuitry designed with the scheme in this invention can have a charge voltage as high as that of the main cells of the Marx modulators, and therefore have high stored electrical energy. It can actively compensate the voltage droop of the MMC bank of the Marx modulator in multiple times with each compensation cell.

The new compensation circuitry will operate with a feedforward correction system. If the voltage of the main cell bank of the Marx modulator droops to a level that a compensation action is needed, the feedforward correction system will trigger the solid-state switches of the compensation circuitry so that the electrical energy stored in the compensation circuitry is released. The inductive components in the compensation circuitry will prevent its entire voltage from adding all at once to that of the MMC bank of the Marx modulator, thus narrow the pulse flattop fluctuation range and smooth out the voltage compensation action. The controllable compensation actions can be repeated many times as long as the sufficient stored energy in the compensation circuitry remains. Using this multiple compensation principle, the number of compensation cells can be significantly reduced and the design of the compensation circuitry will be greatly simplified. The voltage droop of the MMC banks of the Marx modulators will be well controlled in a range required by the load.

Two embodiments of the compensation circuitry are disclosed in the present invention. The first embodiment is a compensation cell whose topology is similar to the main cells of the Marx modulators. Only an inductor and a diode are added in the compensation cell for controlling the compensation energy flux and smoothing the compensation voltage curves. The second embodiment is a compensation circuitry cell that is transformed from a buck converter circuit. Both embodiments comprise inductive components, diodes, capacitors and fast speed solid-state switches, and are controlled by a feedforward correction system.

The present invention can be used to design a compensation circuitry of long-pulse Marx modulators, which are extensively used by particle accelerators and radars. Furthermore, a Marx modulator is a pulser that outputs high voltage pulses that are widely used in weapon effect simulators, fusion research devices, lasers etc. When the pulser operates with a small load or outputs a long pulse, a compensation circuitry will be needed to maintain a constant voltage output, which is addressed by our invention. In addition to these applications, our compensation scheme can also be used by low-voltage pulsers with several kilovolts or less, because the compensation circuitries can be easily scaled down.

### DESCRIPTION OF THE DRAWINGS

For a better understanding of the present invention and further features thereof, reference is made to the following descriptions which are to be read in conjunction with the accompanying drawings wherein.

FIG. 1a is the first embodiment of this invention and FIG. 1b is the first embodiment with an additional solid-state switch for protecting load arcing;

FIG. 2a is the second embodiment of this invention and FIG. 2b is the equivalent circuit of the second embodiment;

FIG. 3 is a schematic of experimental setup for the first embodiment.

FIG. 4 shows the compensation actions observed when the first embodiment was tested;

FIG. 5a and FIG. 5b indicate the compensation curves when capacitance of the MMC bank was varied from 3 μf to 6 μf, respectively.

### DESCRIPTION OF THE INVENTION

Initial compensation circuitries described by J. Casey et al (Particle Accelerator Conference 2005) and G. Leyh (2005 Pulsed Power Conference & Particle Accelerator Conference 2007), as mentioned before, have an identical topology as those of main cells of Marx modulators, and the charge voltage for the compensation cells is different from that of main cells, with the latter being much higher. Those initial compensation cells have only one-time compensation action per cell during one voltage pulse. An example of the Marx modulator, including its MMC bank and its compensation cell bank, was given by G. Leyh in the citation above in which the compensation cell bank is called as a vernier cell bank. The MMC bank, comprising of a plurality of main cells, is in series with a vernier cell bank that also has a plurality of vernier cells, i.e. compensation cells. The modulator has a negative output pulse, as do the embodiments to be described below. The number of vernier cells that should be used in a vernier cell bank, i.e. a compensation cell bank can be computed according to the principle that the energy stored in a vernier cell bank should at least make up the energy difference between the ideal pulse energy and the actual, decayed pulse energy absorbed by a load. Based on this principle, the following calculations yield the number of vernier cells needed:

### (1) Energy Attenuation of the MMC Bank

The voltage V(t) output by a MMC bank having a total capacitance C and a load impedance R in series with the bank attenuates in time according to:

$$V ( t ) = {V}_{0} {e}^{- \frac{t}{RC}} , \qquad ( 1 )$$

where V₀ is the initial output voltage amplitude of the MMC bank, equal to the dc charge voltage times the number of stages of the MMC erected, and t is discharging time. The output power P(t) of the MMC bank decays in a form of:

$$P ( t ) = \frac{{V ( t )}^{2}}{R} . \qquad ( 2 )$$

If E(t) is the total energy dissipated in the load R, then:

$$E ( t ) = {\int }_{0}^{t} P ( t ) d t = \frac{1}{2} \times {CV}_{o}^{2} ( 1 - {e}^{- \frac{2 t}{RC}} ) . \qquad ( 3 )$$

### (2) Energy Needed by a Load for an Ideal Rectangular Voltage Pulse

For an ideal rectangular voltage pulse (amplitude of V₀), the energy Eᵣ(t) of the pulse loss in the load with an impedance of R is:

$${E}_{r} ( t ) = \frac{{V}_{0}^{2}}{R} \times t . \qquad ( 4 )$$

(3) Energy Stored in One Vernier Cell (i.e. One Compensation Cell), Eᵥ(t), is:

$${E}_{v} ( t ) = \frac{1}{2} \times {C}_{v} {V}_{v}^{2} , \qquad ( 5 )$$

where Cᵥ is the capacitance and Vᵥ is the charge voltage of the vernier cell.

### (4) Minimum Number of Compensation Cells

The electrical energy stored in the vernier cell bank should make up the difference between Eᵣ(t) and E(t). Thus, the minimum number, N, of the compensation cells can be calculated from the equation below:

N=(Eᵣ(t)−E(t))/Eᵥ(t) (6)

From the above calculations, it is seen that the minimum number, N, of the compensation cells is inversely proportional to the amplitude square of the charge voltage, Vᵥ, of the compensation cells. Increasing the charge voltage will greatly reduce the number of the compensation cells, thus helping to simplify the Marx modulator and saving cost. In certain applications such as the International Linear Collider project, the flatness of an output voltage pulse of the Marx modulator is required to be in a very small range, i.e. 1% or less, which requires a very low charge voltage for a compensation cell having only one time compensation action to stay within the range. Thus many compensation cells for the Marx modulators are needed in this conventional scheme. The present invention, by smoothing the output voltage of the compensation cell employing solid-state switches, inductors and diodes, will greatly raise the charge voltage of a compensation cell (as high as that of the charge voltage of the MMC) while keeping the flattop fluctuation of the voltage pulse in the required small arrange, and thus reduce the number of compensation cells.

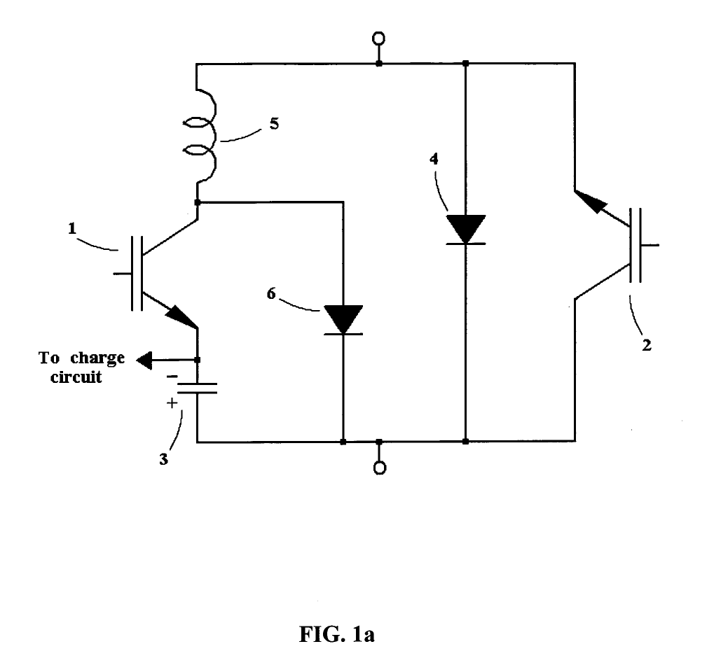

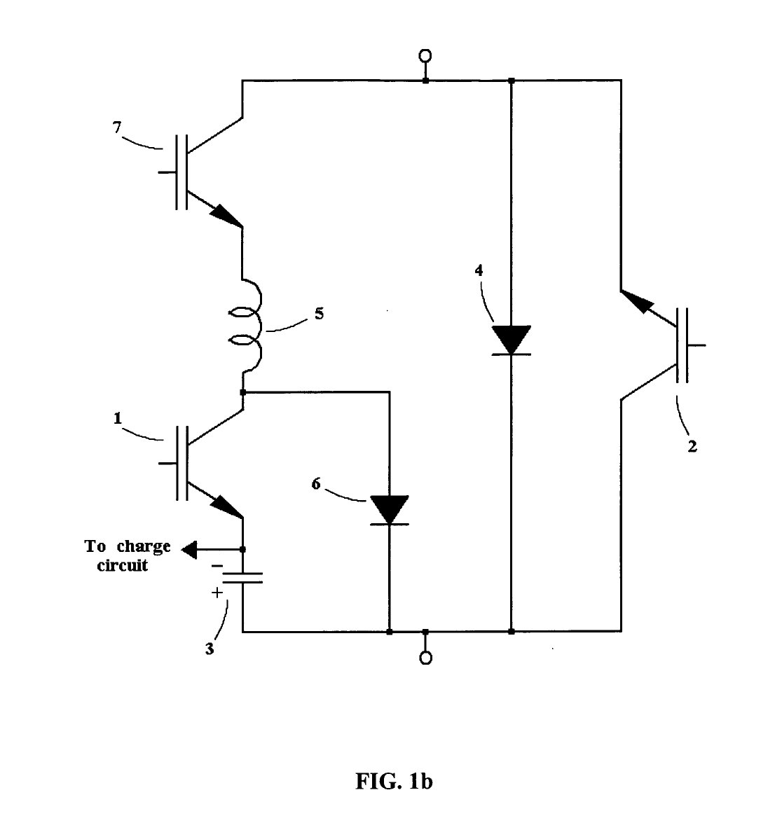

FIG. 1a illustrates the first embodiment of the compensation circuitry of the present invention. It includes main switch 1, charge switch 2, compensation capacitor 3, main discharge diode 4, compensation inductor 5, and compensation diode 6. Two other important components are added, i.e. compensation inductor 5 and compensation diode 6. With these two critical components, the compensation cell can perform multiple compensation actions. As the voltage pulse output by the Marx modulator droops, main switch 1 is turned on immediately by the feedforward correction system. The voltage across compensation capacitor 3 is added on the voltage of the MMC bank gradually because of the counteraction of inductor 5. Once the voltage of the main Marx circuit recovers, main switch 1 is turned off and the magnetic energy stored in inductor 5 continues to compensate the main Marx circuit through diode 6. But the compensation voltage will diminish with time as the stored magnetic energy is depleted, and the total voltage of the Marx modulator begins to droop again. When the total voltage reduces to a certain level, the compensation cycle starts over, as long as there is sufficient electrical energy stored in capacitor 3, to compensate the voltage droop of the MMC bank. Although the fall time of the voltage pulse output by the MMC bank is affected by the inductance of inductor 5, the impact of the inductance is limited by the relatively fast compensation action. The value of the inductance needed is correlated to the switching speed of the solid-state switch. The faster the speed of the solid-state switch has, the less inductance the compensation cell needs and the less impact the inductance of the inductor 5 has.

FIG. 1b describes an improvement of the compensation circuit in FIG. 1a. A third solid-state switch, load protection switch 7, is added in the circuit for protecting the load of the Marx modulator, which may be an rf load such as a klystron. Switch 7 will rapidly cut off the compensation current in case of load arcing. However, the switch does not directly contribute to normal compensation functions.

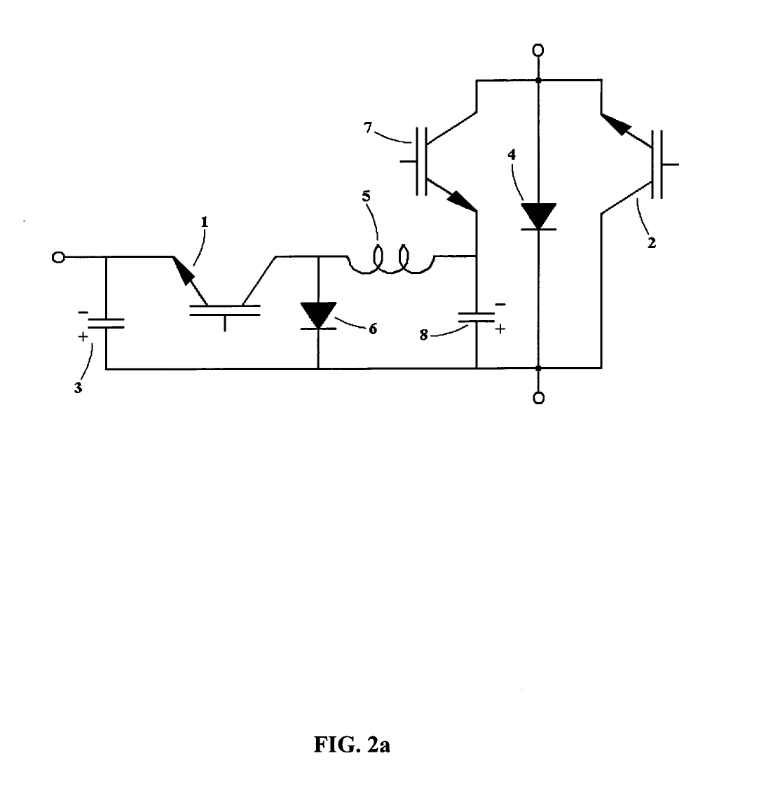

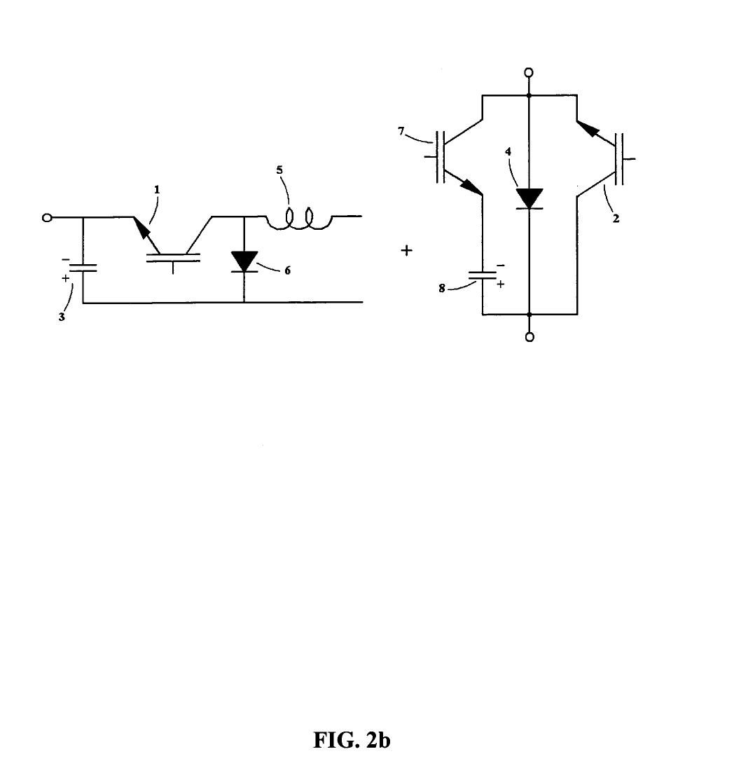

FIG. 2a is the second embodiment of the present invention. Compared with the first embodiment shown in FIG. 1a, the second embodiment has similar topology but one more capacitor, direct compensation capacitor 8. The first embodiment is a special case of the second one, with capacitor 8 in the second embodiment having a value of zero. The advantage of direct compensation capacitor 8 is that the capacitor can alleviate the current load from inductor 5 and diode 6 because the current of the MMC bank will pass through direct compensation capacitor 8.

Separately, the second embodiment can be viewed in two parts (see FIG. 2b). The left part in FIG. 2b is a buck converter. When this part works in switching mode power supply (SMPS), it has a variable output voltage that is related to the voltage of the capacitor 3 and the duty cycle of the switch 1. However, the SMPS mode is not used in the compensation actions. Instead, in the present invention, switch 1 is triggered by a feedforward correction system whenever the compensation is needed. Capacitor 3 will be charged to a high voltage, which can be identical to that of MMC, so that it stores more electrical energy to be used in the ensuing compensation actions. The right part in FIG. 2b is the topology of the main Marx cell, whose capacitor 8 will receive the adjustable compensation energy from the left part. The compensation energy flux, and thus the voltage of capacitor 8, are adjusted through the triggering of switch 1.

### PRELIMINARY EXPERIMENTS

Low-voltage experiments were performed for the compensation circuitry of the first embodiment (see FIG. 1a). The experimental purpose was to find the evident of the feasibility of our compensation cell design scheme, i.e. multiple compensations regulated by the solid-state switch and the inductor. For simplicity, only one compensation cell was used in the test. The charge voltage of the compensation cell was 6 V. The capacitance of the compensation cell was 30 μF. MMC bank (its total capacitance is 3 μF) with the output voltage from ˜55 V to 75 V was used. The entire experimental setup is referred to the Marx modulator used by G. Leyh (Particle Accelerator Conference 2007) but with a scaled down charge voltage, and is shown in FIG. 3 when both banks of the Marx modulator are erected.

In the tests, switch 1 and 2 adopted IGBT switches. IGBT (rated at 100V) switches were driven by driver circuits and controlled by a single-board computer. A divider that was in series of the load was utilized to monitor the voltage change on the load and the voltage of the divider was sent to the computer for the purpose of controlling switch 1 to start the compensation actions.

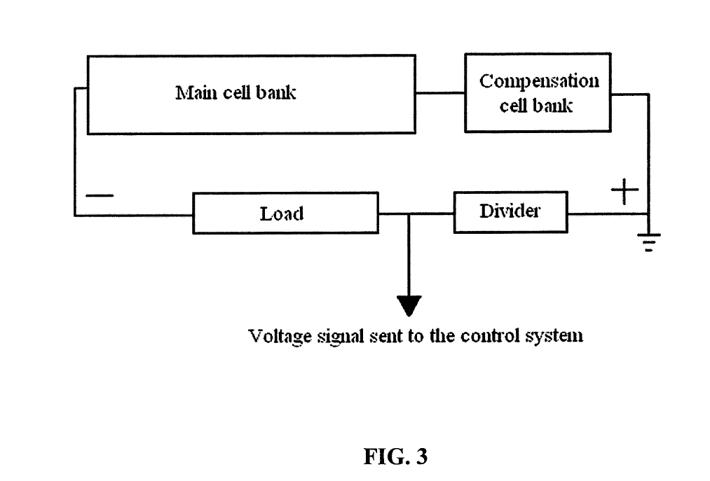

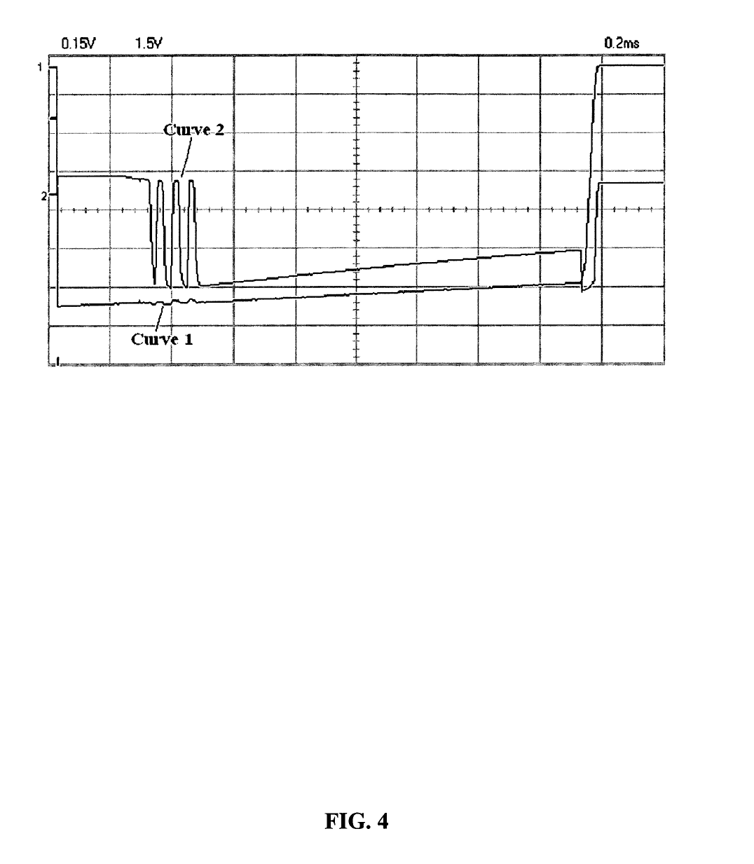

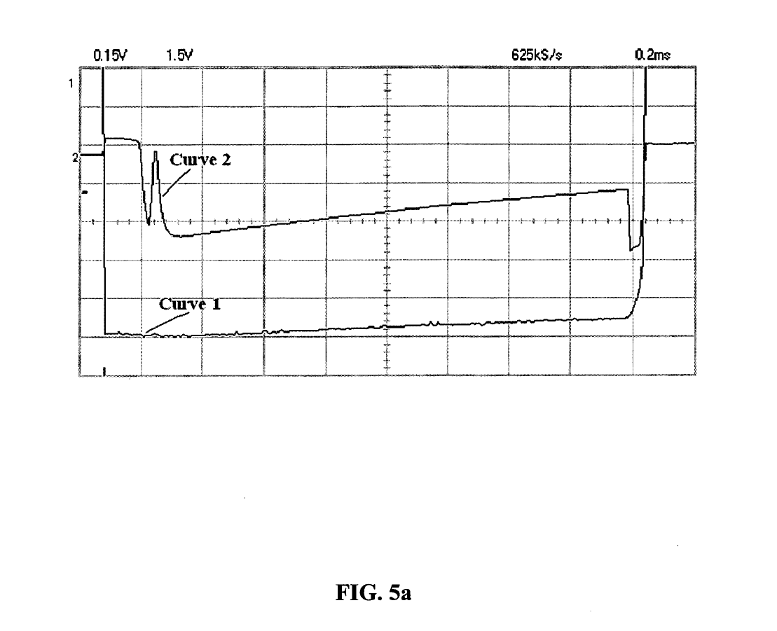

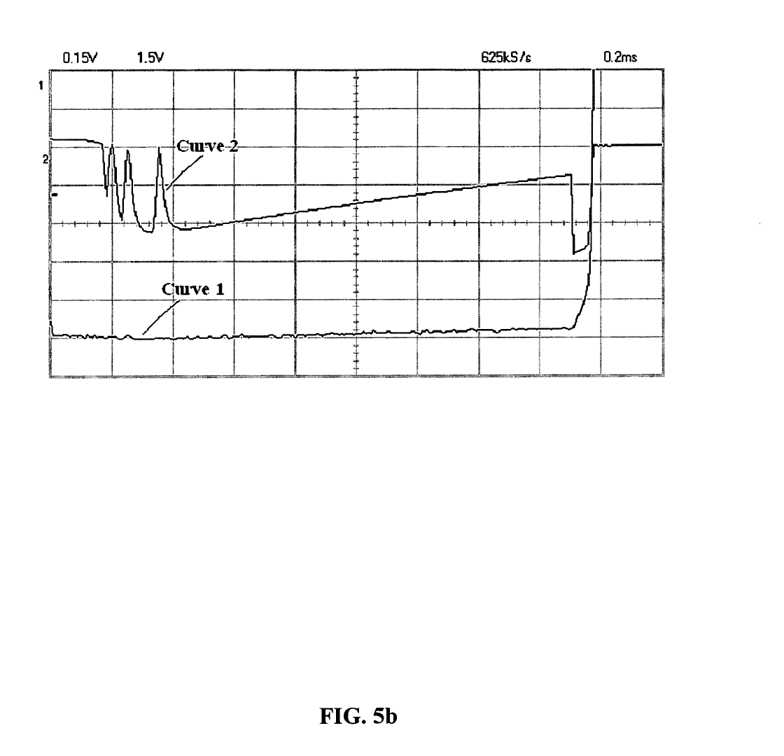

FIG. 4 shows that the compensation voltage curve, output by the single cell and regulated by the computer, was observed in the experiments, where the overall voltage pulse was 1.7 ms long. The horizontal axis in FIG. 4 is time (same in the following FIGS. 5a and 5b). The compensation actions (Curve 2 in FIG. 4) made small ripples on the overall voltage pulse (Curve 1 in FIG. 4) and maintained its level up to t=500 μs. After that, the overall voltage pulse decayed as the stored energy of the compensation cell was exhausted, and from that time the compensation cell (mainly, the main switch 1) was turned on all the way till the end of the voltage pulse.

Further experiments were conducted for finding the relationship of the MMC's capacitance to that of compensation cell. Here we define the adequate compensation period, tₐ, which refers to the time from the initial trigger of switch 1 to the instant that the energy in the compensation cell is no longer sufficient to compensate the voltage output by the MMC bank (the voltage began to droop all the way from then). At time tₐ, the IGBT of the compensation cell would be turned on and would remain on. From the equations above, we can induce that the adequate compensation period tₐ should become longer when the capacitance of the MMC increases because less energy is needed to compensate the voltage droop. We have observed this phenomenon during our experiments when we varied the capacitance of the MMC bank and kept other experimental conditions nearly the same. It is shown that tₐ is around 240 μs for the capacitance of the MMC at 3 μF (see FIG. 5a) and around 400 μs when the value is changed to 6 μf. (see FIG. 5b). The observation agrees well with the prediction of the equations above.

While the invention has been described with reference to its preferred embodiments, those skilled in the art will understand that various changes may be made and equivalents may be substituted for elements thereof without departing from the true spirit and scope of the invention. In addition, many modifications may be made to adapt a particular situation or material to the teachings of the invention without departing from its essential teachings.

What is claimed is:

1. Compensation circuitries for the voltage droop of the solid-state Marx modulators comprising key components of high voltage solid state switches, inductors, and high voltage diodes capable of being charged to high voltage, e.g. identical voltage to that of Marx main cells.

2. The compensation circuitries of claim 1 wherein said solid-state switch is controlled by a computer of the feedforward correction system.

3. The compensation circuitries of claim 1 wherein multiple compensation actions are made under the control of a feedforward correction system. Electrical energy stored in the compensation cells of claim 1 is released in a controllable manner, through the collective actions of the solid-state switch, the inductor and the diode, to compensate the voltage droop of the Marx modulators and smooth the flattop of the voltage pulse.

4. The compensation circuitry of claim 1, making use of the buck converter circuit, charges a variable voltage for the compensation capacitor that is located in the compensation cell that has the same topology as that of the main cell of the Marx modulators, under the control of a feedforward correction system.
